(19) United States
(12) Patent Application Publication
(10) Pub. No.: US 2010/0224618 A1
(43) Pub. Date: Sep. 9, 2010

(54) ELECTRIC HEATING CONTAINER AND ELECTRIC HEATING METHOD

(76) Inventor: Kevin Lin, Kowloon (HK)

Correspondence Address: LADAS & PARRY LLP, 224 SOUTH MICHIGAN AVENUE, SUITE 1600, CHICAGO, IL, 60604, US

(21) Appl. No.: 12/670,163

(22) PCT Filed: Dec. 21, 2007
(86) PCT No.: PCT/CN07/03725

§ 371 Date: Jan. 22, 2010

(30) Foreign Application Priority Data
Jul. 27, 2007 (CN) PCT/CN2007/002266

(51) Int. Cl. H05B 3/02

(52) U.S. Cl. 219/438

(57) ABSTRACT

An electric heating container includes a container body (3) having a top opening for putting articles to be heated into the electric heating container and a bottom opening, a bottom plate (2) sealed to the bottom opening of the container body (3), and a resistance film (1) coated on bottom surface of the bottom plate (2). An electric heating method is also provided.

### CROSS-REFERENCE TO RELATED APPLICATIONS

The application claims the priority benefits of PCT Application No. PCT/CN2007/002266 filed on Jul. 27, 2007, the contents of which are hereby incorporated by reference in its entirety.

### FIELD OF THE INVENTION

The present invention generally relates to a heating container and a heating method, and more particularly to an electric heating container and an electric heating method.

### BACKGROUND OF THE INVENTION

We have always been depending on drinks or foods to supply energy we need since time immemorial. If the drinks or foods could be heated or kept warm appropriately, the taste and smell of the drinks or foods, such as Chinese tea, coffee, ginger tea, milk, beef, pork, chicken, could be improved, in addition to the advantages of hygiene, sense of warm and supplement of energy.

Currently, the traditional heating methods generally include two manners, i.e. heating with gas or heating with electric heating wire.

The heating method with gas is of low thermal efficiency, and may generate naked flame, consume oxygen and incur danger of fire. It may also cause carbon monoxide poisoning and leakage of gas, as well as increase the ambient temperature. Therefore, such kind of method is disadvantageous.

The traditional heating method with electric heating container is also of low thermal efficiency, and may increase the ambient temperature. The heating container heats foods or drinks indirectly and non-uniformly whose thermal conductivity is not good, and has a short working life. Besides, such container is of large-sized and heavy.

To obtain good thermal efficiency and lower energy consumption, a novel electric heating container is desired, which would not generate naked flame and not consume oxygen with uniform heat distribution and long working life. It could also avoid rapid raise of the ambient temperature and is of environment protection.

### SUMMARY OF THE INVENTION

To overcome the above-mentioned drawbacks, the present invention mainly aims to provide an electric heating container, which is advantageous in that it is of good thermal efficiency with low energy consumption, generates uniform thermal energy with a long working life, does not generate naked flame and consume oxygen, does not incur rapid raise of the ambient temperature, and is of environment protection.

One aspect of the present invention provides an electric heating container which comprises: a container body including a top opening through which articles to be heated are put into the electric heating container and a bottom opening; a bottom plate hermetically attached to the container body at the bottom opening thereof; and a resistance film coated on a bottom surface of the bottom plate.

The container body may be made of heat-resistance glass, heat-resistance ceramics, heat-resistance plastics or metals. The bottom plate could be in a plate form, and be made of heat-resistance glass, ceramics or metals coated with an insulating layer. If the bottom plate is made of metals coated with an insulating layer, the bottom plate could be connected to the ground. The resistance film may be a semiconductor electric heating resistance film, and a conductive terminal could be provided at each of opposite sides of the resistance film for supplying power to the resistance film.

Preferably, the electric heating container may further comprise a separator which is provided at the top of the bottom plate and is hermetically attached to the container body at the bottom opening thereof. The separator may be in the form of a plate, a ring or a screen plate, and be made of heat-resistance glass, ceramics or metals. Preferably, the separator covers a top surface and a side surface of the bottom plate.

Or, the separator may be a film layer coated on a top surface of the bottom plate, and the film layer could be made of heat-resistance glass, ceramics or metals. The film layer could be in the form of a plane, a ring or a screen. Preferably, the film layer could be coated on the top surface and a side wall of the bottom plate. In addition, the separator could be connected to the ground.

Preferably, the electric heating container may further comprise a strengthen element which is tightly attached to an inner wall of the container body around the bottom opening of the container body, and the separator and/or the bottom plate are hermetically attached to the strengthen element. The strengthen element may be made of heat-resistance glass, ceramics or metals. Preferably, the strengthen element could be connected to the ground.

In another aspect, the present invention provides an electric heating method which comprises: coating a resistance film at a bottom part of an electric heating container; and supplying power to the resistance film to heat articles to be heated within the electric heating container with thermal energy generated from the resistance film.

Preferably, the resistance film could be supplied with direct current or alternating current at a voltage of 3V-300V.

Preferably, a separator could be provided at the top of a bottom plate of the electric heating container, and the separator could be connected to the ground.

Preferably, a strengthen element could be provided at an inner wall at the bottom of the electric heating container, and the strengthen element could be connected to the ground.

With the electric heating container and method of the present invention, the thermal energy generated from the resistance film could be transferred to the bottom plate or the combination of the bottom plate and separator directly and uniformly, to heat the articles to be heated within the container body. Thus, the present invention is of safety and has good performance in heating and keeping warm. The ground connection of the separator could lower or eliminate the charges accumulated in the articles to be heated during the course of operation, which further improves the safety of the present invention. In addition, the electric heating container may further comprise a strengthen element, to strengthen the container and uniform the thermal energy generated during operation. The ground connection of the strengthen element could lower or eliminate the charges accumulated in the articles to be heated, to further improve safety of the present invention.

### BRIEF DESCRIPTION OF THE DRAWINGS

The present invention will be described in detail with reference to the accompanying drawings, in which,

FIG. 1 is a perspective explosive view of a first embodiment of the electric heating container according to the present invention;

FIG. 2 is a perspective explosive view of a second embodiment of the electric heating container according to the present invention;

FIG. 3 is a partial cross-sectional view of the electric heating container shown in FIG. 1;

FIG. 4 is a partial cross-sectional view of the electric heating container shown in FIG. 2;

FIG. 5 is a perspective explosive view of a first variant of the second embodiment of the electric heating container according to the present invention;

FIG. 6 is a perspective explosive view of a second variant of the second embodiment of the electric heating container according to the present invention;

FIG. 7 is a perspective explosive view of a third variant of the second embodiment of the electric heating container according to the present invention;

FIG. 8 is a perspective explosive view of a fourth variant of the second embodiment of the electric heating container according to the present invention;

FIG. 9 is a perspective explosive view of a fifth variant of the second embodiment of the electric heating container according to the present invention;

FIG. 10 is a perspective explosive view of a sixth variant of the second embodiment of the electric heating container according to the present invention;

FIG. 11 is a perspective explosive view of a seventh variant of the second embodiment of the electric heating container according to the present invention;

FIG. 12 is a perspective explosive view of a third embodiment of the electric heating container according to the present invention;

FIG. 13 is a partial cross-sectional view of the electric heating container shown in FIG. 12; and

FIG. 14 is a perspective explosive view of a fourth embodiment of the electric heating container according to the present invention.

### DETAILED DESCRIPTION OF THE INVENTION

The electric heating container of the present invention is a container for heating articles to be heated, such as food or liquid, contained therein. The container may be, for example, a kettle, a steamer, a hot pot, a rice cooker, a wok, a heater, an industrial boiler, etc. For illustration purposes, the accompanying drawings only show kettles as embodiments of the present invention. However, the present invention could also be applied to any of the above-mentioned heating containers. The details of the present invention will be described with reference to the accompanying drawings.

As shown in FIG. 1, the electric heating container of the present invention comprises a container body 3, a bottom plate 2 and a resistance film 1. The container body 3 has a top opening for inputting the articles to be heated to the container body 3 and a bottom opening. The bottom plate 2 is hermetically attached to the container body 3 at the bottom opening thereof, as shown in FIG. 3. For example, the bottom plate 2 may be adhered to the container body 3 by means of silicone resin, or be welded directly together with the container body 3. The resistance film 1 is attached to a surface of the bottom plate 2 opposite to the container body (i.e. the bottom surface of the bottom plate 2). For instance, the resistance film 1 could be coated on the bottom surface of the bottom plate 2. The resistance film 1 could be a semiconductor electric heating resistance film. Conductive terminals 11 and 12 are provided at opposite sides of the resistance film 1, for supplying power to the latter.

The container body 3 may be made of heat-resistance glass, heat-resistance ceramics, heat-resistance plastics, metals (such as stainless steel), or other suitable materials. The bottom plate 2 could be in a plate form, and made of materials suitable for coating resistance film 1 thereon, such as heat-resistance glass, ceramics or metals coated with an insulating layer. Preferably, when the bottom plate 2 is made of metals coated with an insulating layer, it is possible to connect the bottom plate to the ground by leads or other means (not shown in the figures), to ensure the safety of the electric heating container.

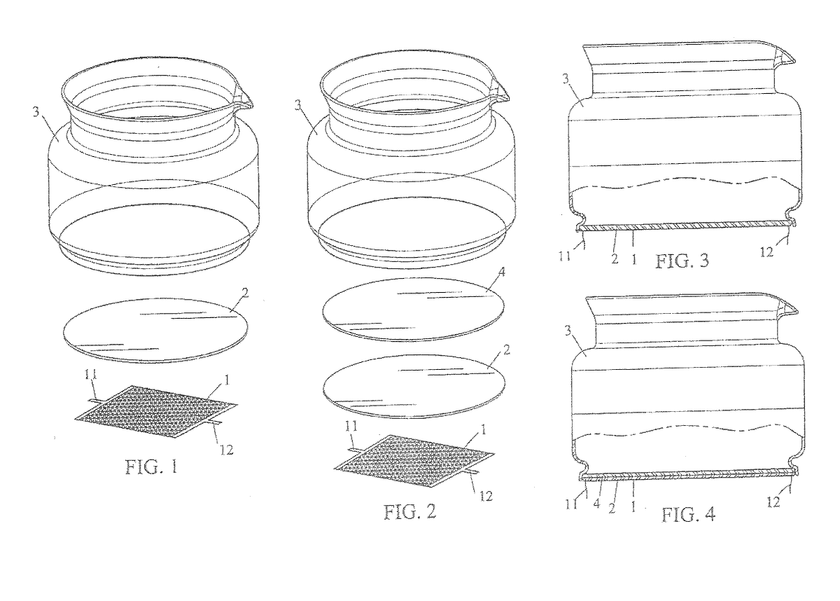

FIG. 2 illustrates the second embodiment of the electric heating container according to the present invention. The components of the second embodiment are identical to those of the first embodiment, except that the second embedment further comprises a separator 4 provided at the top of the bottom plate 2, and is hermetically attached to the container body 3 at the bottom opening thereof, as shown in FIG. 4. For example, the separator 4 may be adhered to the container body 3 by means of silicone resin, or be welded directly together with the container body 3.

The separator 4 may be made of heat-resistance glass, ceramics, metals, etc. With the separator 4, it could prevent the articles to be heated within the present electric heating container from leakage perfectly, thus the articles could be heated more safely and evenly.

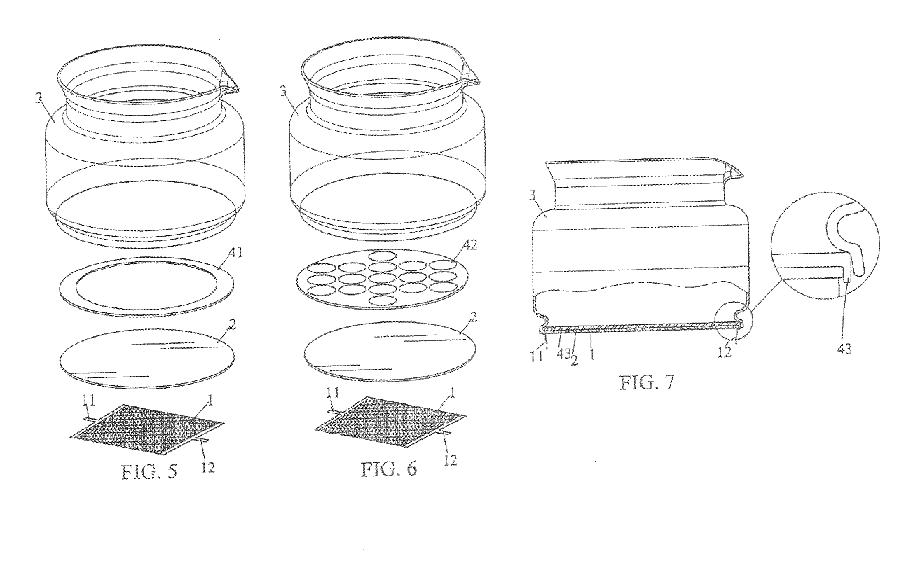

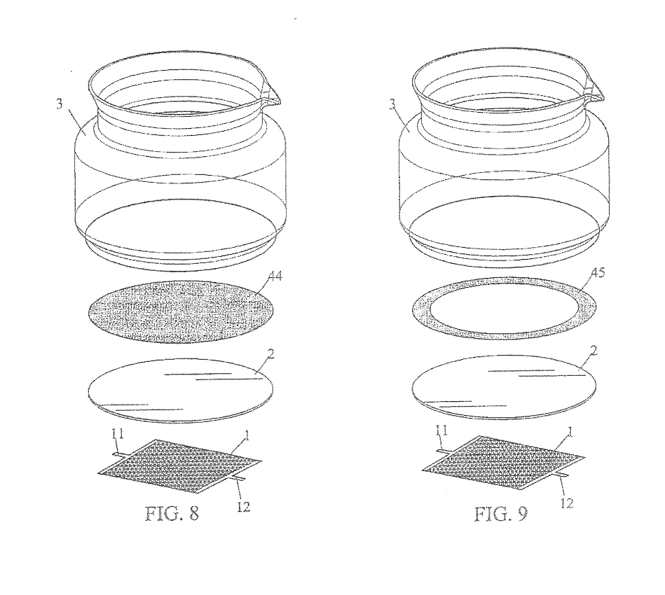

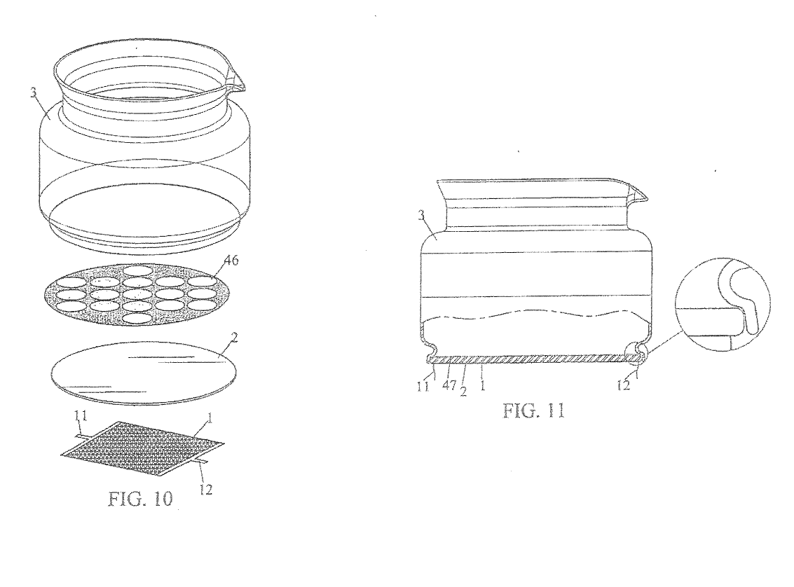

The separator 4 shown in FIG. 2 is in a plate form. However, the separator may be in any suitable form. For example, FIG. 5-11 illustrate a plurality of variants of the second embodiment of the present electric heating container respectively. In those variants, except for separators, the other components are identical to those of the embodiment shown in FIG. 2. In the first variant shown in FIG. 5, the separator 41 is in a ring form, while the separator 42 in the second variant shown in FIG. 6 is in form of a screen plate with a plurality of through holes. FIG. 7 illustrates the third variant of the second embodiment of the present invention, in which the separator 43 covers the top surface and side surface of the bottom plate 2 and is attached to the bottom plate 2. FIG. 8 illustrates the fourth variant of the second embodiment of the present invention, in which the separator 44 is a film layer coated on a surface of the bottom plate 2 facing to the container body 3 (i.e. the top surface of the bottom plate 2), and the film layer is in a plane form. The fifth and sixth variants shown in FIGS. 9 and 10 are similar to the fourth variant shown in FIG. 8, except that the separator 45 in the fifth variant is a annular film layer, while the separator 46 in the sixth variant is a screen film layer with a plurality of through holes. FIG. 11 illustrates the seventh variant of the present second embodiment, in which the separator 47 is a film layer coated on the top surface and side surface of the bottom plate 2. The above-mentioned film layers may be made of metals, ceramics, heat-resistance glass or other suitable materials.

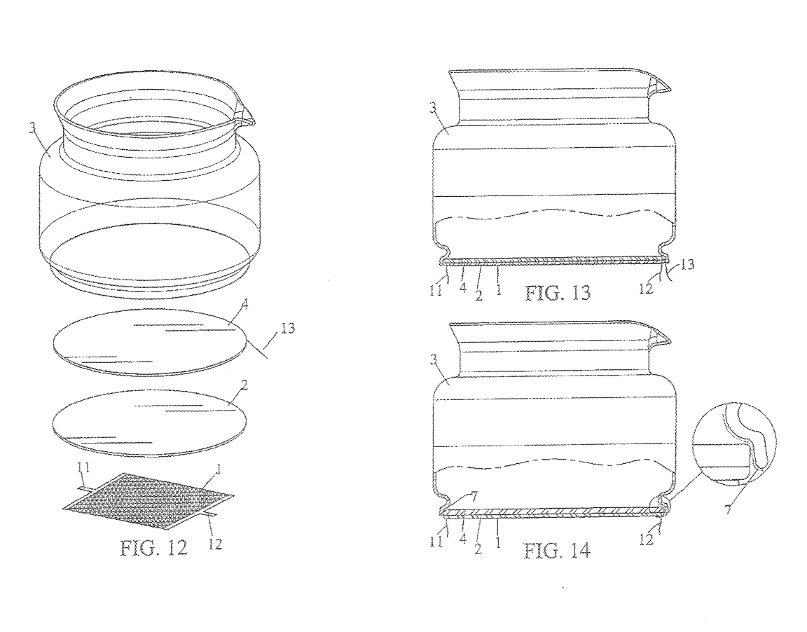

FIGS. 12 and 13 illustrates the third embodiment of the electric heating container of the present invention. The third embodiment is similar to the second embodiment shown in FIG. 2, except that the separator 4 of the third embodiment is connected to the ground by leads 13 or other suitable means. As the separator 4 is connected to the ground, the charges accumulated in the articles to be heated within the container body 3 during operation could be lowered or eliminated, which improve the safety of the heated articles.

FIG. 14 illustrates the fourth embodiment of the electric heating container of the present invention. The components of the fourth embodiment are identical to those of the above-mentioned second embodiment, except that the fourth embodiment further comprises a strengthen element 7. As shown in FIG. 14, the strengthen element 7 is tightly attached to an inner wall of the container body 3 around the bottom opening of the container body. Then, the separator 4 and/or the bottom plate 2 are attached to the strengthen element 7 hermetically. Thus, the electric heating container of the present invention could be strengthened, and the thermal energy generated during heating could be uniformed. Similar to the embodiment shown in FIG. 13, the strengthen element 7 may be connected to the ground by leads or other suitable means (not shown in the figures), thus the charges accumulated in the articles to be heated within the container body 3 during operation could be lowered or eliminated, which improve the safety of the heated articles. The strengthen element 7 could be made of heat-resistance glass, ceramics, metal or other suitable materials.

The electric heating method of the present electric heating container is that the resistance film is supplied with direct current or alternating current via conductive terminals to generate thermal energy, and the thermal energy heats the articles to be heated within the electric heating container uniformly. The voltage of the supplied direct current or alternating current may be 3V-300V. In addition, the separator and/or strengthen element of the electric heating container may be connected to the ground, thus, the charges accumulated in the articles to be heated could be lowered or eliminated.

With the electric heating container and method of the present invention, the thermal energy generated from the resistance film could be transferred to the bottom plate or the combination of the bottom plate and separator directly and uniformly, to heat the articles to be heated within the container body. Thus, the present invention is of safety and has good performance in heating and keeping warm. The ground connection of the separator could lower or eliminate the charges accumulated in the articles to be heated during the course of operation. In addition, the electric heating container may further comprise a strengthen element, to strengthen the container and uniform the thermal energy generated during operation. The ground connection of the strengthen element could lower or eliminate the charges accumulated in the articles to be heated, to improve safety of the present invention.

Although the description of the present invention is made with reference to the preferred embodiments, the present invention is not limited to these embodiments. Various modifications and changes can be made to the invention by those skilled in the art without departing from the spirit and scopes of the present invention.

1. An electric heating container comprising:
a container body including a top opening through which articles to be heated are put into the electric heating container and a bottom opening;
a bottom plate hermetically attached to the container body at the bottom opening thereof; and
a resistance film coated on a bottom surface of the bottom plate.

2. The electric heating container of claim 1, wherein the container body is made of heat-resistance glass, heat-resistance ceramics, heat-resistance plastics or metals.

3. The electric heating container of claim 1, wherein the bottom plate is in a plate form, and is made of heat-resistance glass or ceramics.

4. The electric heating container of claim 1, wherein the bottom plate is in a plate form, and is made of metals coated with an insulating layer.

5. The electric heating container of claim 4, wherein the bottom plate is connected to the ground.

6. The electric heating container of claim 1, wherein the resistance film is a semiconductor electric heating resistance film.

7. The electric heating container of claim 6, wherein a conductive terminal is provided at each of opposite sides of the resistance film for supplying power to the resistance film.

8. The electric heating container of claim 1, further comprising a separator which is provided at the top of the bottom plate and is hermetically attached to the container body at the bottom opening thereof.

9. The electric heating container of claim 8, wherein the separator is in the form of a plate, a ring or a screen plate, and is made of heat-resistance glass, ceramics or metals.

10. The electric heating container of claim 9, wherein the separator covers a top surface and a side surface of the bottom plate.

11. The electric heating container of claim 8, wherein the separator is a film layer coated on a top surface of the bottom plate, and the film layer is made of heat-resistance glass, ceramics or metals.

12. The electric heating container of claim 11, wherein the film layer is in the form of a plane, a ring or a screen.

13. The electric heating container of claim 12, wherein the film layer is coated on the top surface and a side wall of the bottom plate.

14. The electric heating container of claim 8, wherein the separator is connected to the ground.

15. The electric heating container of claim 8, further comprising a strengthen element which is tightly attached to an inner wall of the container body around the bottom opening of the container body, and the separator and/or the bottom plate are hermetically attached to the strengthen element.

16. The electric heating container of claim 15, wherein the strengthen element is made of heat-resistance glass, ceramics or metals.

17. The electric heating container of claim 15, wherein the strengthen element is connected to the ground.

18. An electric heating method comprising:
coating a resistance film at a bottom part of an electric heating container; and
supplying power to the resistance film to heat articles to be heated within the electric heating container with thermal energy generated from the resistance film.

19. The electric heating method of claim 18, wherein the resistance film is supplied with direct current or alternating current at a voltage of 3V-300V.

20. The electric heating method of claim 18, wherein a separator is provided at the top of a bottom plate of the electric heating container, and the separator is connected to the ground.

21. The electric heating method of claim 18, wherein a strengthen element is provided at an inner wall at the bottom of the electric heating container, and the strengthen element is connected to the ground.
